(19) United States
(12) Patent Application Publication
(10) Pub. No.: US 2003/0170447 A1
(43) Pub. Date: Sep. 11, 2003

(54) Fluorescence-enhanced bead

(75) Inventors: Minoru Ootsubo, Tokyo (JP); Takeo Tanaami, Tokyo (JP)

Correspondence Address: ARMSTRONG,WESTERMAN & HATTORI, LLP, 1725 K STREET, NW, SUITE 1000, WASHINGTON, DC, 20006, US

(73) Assignee: YOKOGAWA ELECTRIC CORPORATION, Tokyo (JP)

(21) Appl. No.: 10/383,506

(22) Filed: Mar. 10, 2003

(30) Foreign Application Priority Data
Mar. 11, 2002 (JP) 2002-064865

(51) Int. Cl. B32B 17/02

(52) U.S. Cl. 428/323; 428/402; 428/407

(57) ABSTRACT

The fluorescence-enhanced bead of the present invention is intended to achieve a larger surface area and easy treatment, by making a minute spherical shape material into a bead by applying coating similar to fluorescence-enhanced chips onto the surface of the spherical shape material. That is, metal layer is formed on a spherical shape nucleus and a dielectric layer is formed on this metal layer. This easily enhances the intensity of fluorescence generated from a fluorescent material on the surface of this dielectric layer.

### BACKGROUND OF THE INVENTION

1. Field of the Invention

The present invention relates to a fluorescence-enhanced chip that enhances the intensity of fluorescence, and in particular, to a fluorescence-enhanced chip characterized by its shape.

2. Description of the Prior Art

Techniques for measuring the intensity of fluorescence emitted from fluorescent materials are important in the fields of immunology and nucleic acid detection. In the case of detecting proteins or nucleic acids or the like (hereinafter simply called ‘nucleic acid’), a nucleic acid of interest is labeled with a fluorescent material in advance, then this nucleic acid to be detected is identified by its fluorescence emission generated by the irradiation of excitation light.

In this case, the intensity of fluorescence is an index for quantifying the nucleic acid of interest. Accordingly, for the same quantity of fluorescent materials, the more the detected fluorescence is intense, the more the detection sensitivity is high in that system, that is, smaller trace amounts of protein or nucleic acid can become quantified.

For this purpose, enhancing the fluorescence from fluorescent materials of equal quantity is very important in immunology and for the detection of nucleic acid.

U.S. Pat. No. 4,649,280 mentions a fluorescence-enhanced chip, in which the intensity of fluorescence generated from fluorescent material 4 can be enhanced by using a construction having a stack of metal layer 2, dielectric layer 3, and fluorescent material 4 films on glass substrate 1 as shown in FIG. 1.

It is disclosed that the intensity of fluorescence in this case is related to the thickness d of dielectric layer 3, and lithium fluoride (LiF) is used as dielectric layer 3.

However, such conventional fluorescence-enhanced chips have small surface areas that enhance the intensity of fluorescence because they are shaped as flat plates. A somewhat larger size is necessary for identifying the type of nucleic acid of interest. For this purpose, strong excitation light and a large sample quantity are required for the measuring equipment. Consequently, more expensive measuring equipment is required and high sensitivity is hard to achieve.

### SUMMARY OF THE INVENTION

The object of the present invention is to solve the above problems and to realize a fluorescence-enhanced bead whose surface-area is increased compared with nearly equal size chips and which is easy to handle, by making a minute spherical shape material into a bead by applying coatings similar to fluorescence-enhanced chips onto the surface of the spherical shape material.

### BRIEF DESCRIPTION OF THE DRAWINGS

FIG. 1 is a drawing showing an example of conventional flat-plate fluorescence-enhanced chips.

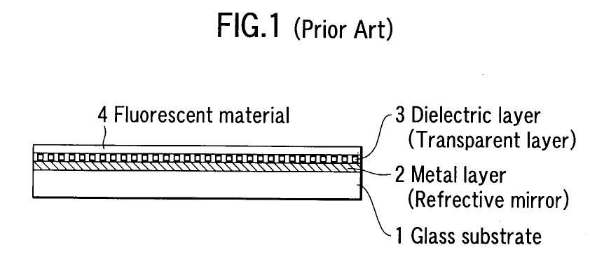

FIG. 2 shows a drawing indicating the configuration of the fluorescence-enhanced bead for an embodiment of the present invention.

FIG. 3 shows a schematic diagram indicating an example of the method in the case of bonding a fluorescence-enhanced bead to a substrate.

### DETAILED DESCRIPTION OF THE PREFERRED EMBODIMENTS

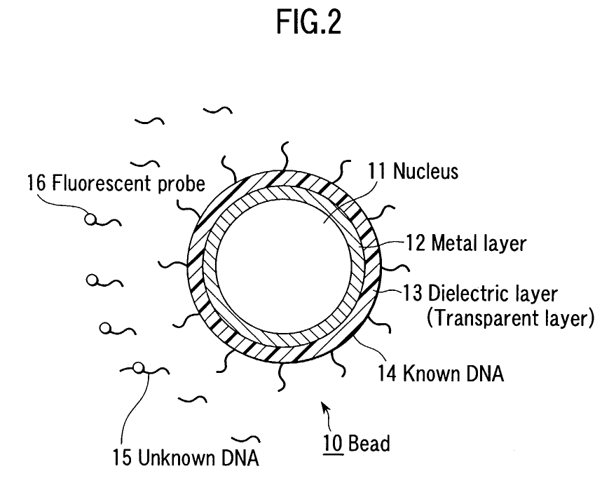

The present invention will be described below in detail with reference to the drawings. FIG. 2 shows a schematic diagram indicating the configuration of the fluorescence-enhanced bead for an embodiment of the present invention. In FIG. 2, numeral 11 denotes the spherical shape nucleus of a magnetic material, numeral 12 a metal layer formed on the surface of nucleus 11, and numeral 13 a dielectric layer (also called a transparent layer) of thickness 100 to 300 nm formed on the surface of metal layer 12.

Metal layer 12 is formed using silver (Ag) or aluminum (Al). Transparent layer 13 is formed with glass, gel or resin.

The method in which the genetic sequence of unknown DNA is examined using fluorescence-enhanced bead 10 of such a construction (hereafter simply called “bead”) is as follows. Known DNA 14 is fixed on the surface of bead 10. The space around bead 10 is filled with a biopolymer solution such as unknown DNA. Unknown DNA 15 complementarily related to known DNA 14 is hybridized with known DNA 14 fixed on the surface of bead 10.

Unknown DNA 15 is labeled with fluorescent probe 16. Unknown DNA bonded with known DNA can be detected through fluorescence measurement, and the genetic sequence of unknown DNA can be identified from the genetic sequence of the bonded known DNA.

In this case, even if the quantity of unknown DNA is extremely small, high-sensitivity measurement is enabled because the fluorescence emitted from a light-excited fluorescent material is enhanced by bead 10.

Such fluorescence-enhanced bead as described above has advantages that the surface area can be increased more easily than with conventional flat-plate fluorescence-enhanced chips, and both high-density integration of biopolymers and high-sensitivity fluorescence measurement can be achieved at the same time.

In addition, such fluorescence-enhanced bead can be suspended in liquids and can improve the contact efficiency with target biopolymer solutions and also improve the speed and bonding accuracy in comparison with flat-plate chips. Further, the bead is easily separated after treatment.

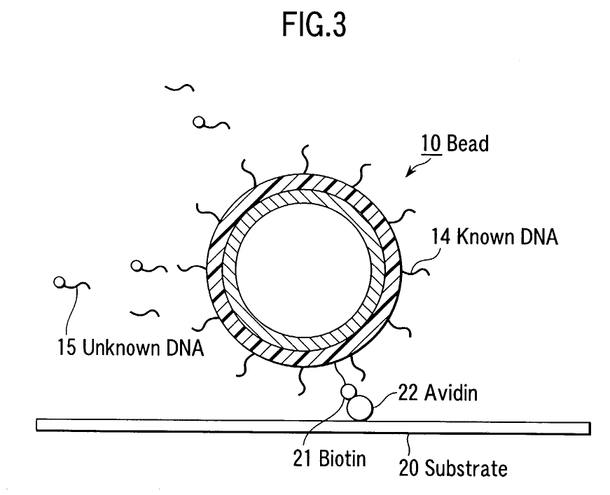

Bead 10 can also be used for forming a site by being fixed to a substrate as shown in FIG. 3. For bonding bead 10 with substrate 20, covalent bonding or, as shown in FIG. 3, avidin-biotin bonding that is composed of avidin 22 bonded with substrate 20 and biotin 21 bonded with bead 10, can be employed.

The present invention is not limited hereupon to the above-mentioned embodiment, but may include many further changes and versions without departing from the scope of spirit thereof.

For example, nucleus 11 may also be composed of solids such as metals, resins, or gels, or of liquid or gas. Also, the material to be fixed to bead 10 is not limited to DNA but may be a type of protein or glyco-chain.

Further, the DNA to be fixed to bead 10 is not limited to known DNA but may also be unknown DNA. The configuration, in which known DNA is floating in a solution and this DNA is made to hybridize with fixed unknown DNA, may also be taken.

As described above, there are the following effects according to the present invention:

(1) The fluorescence-enhanced bead can increase the surface area more easily than conventional flat-plate fluorescence-enhanced chips and can achieve high-density integration of biopolymers and high-sensitivity fluorescence measurement at the same time.

(2) The fluorescence-enhanced bead can be suspended in liquids and can improve the contact efficiency with target biopolymer solutions and also improve the speed and bonding accuracy in comparison with flat-plate chips.

(3) The fluorescence-enhanced bead of the present invention is easily separated after treatment.

What is claimed is:

1. A fluorescence-enhanced bead which is obtained by forming metal layer on a spherical shape nucleus and forming a dielectric layer on the surface of this metal layer, and which can enhance the intensity of fluorescence generated from a fluorescent material distributed on this dielectric layer.

2. A fluorescence-enhanced bead in accordance with claim 1, wherein said nucleus is a solid, liquid or gas of any type of metal, resin or gel.

3. A fluorescence-enhanced bead in accordance with claim 1 or claim 2, wherein said metal layer is made of silver or aluminum.

4. A fluorescence-enhanced bead in accordance with any of claims 1 to 3, wherein said dielectric layer is made of glass, gel or resin.

5. A fluorescence-enhanced bead in accordance with any of claims 1 to 4, wherein DNA or protein or glyco-chain is fixed to said dielectric layer.

6. A fluorescence-enhanced bead in accordance with any of claims 1 to 5, which is formed so as to be able to bond with a substrate by covalent bonding or avidin-biotin bonding.
